(19) United States
(12) Patent Application Publication
(10) Pub. No.: US 2023/0413712 A1
(43) Pub. Date: Dec. 28, 2023

(54) PATH FINDING METHOD AND SYSTEM FOR WEEDING ROBOT

(71) Applicant: ZHEJIANG JIANRUI TECHNOLOGY CO., LTD., Zhejiang (CN)

(72) Inventors: Weiyan ZHU, Zhejiang (CN); Ningning YING, Zhejiang (CN)

(73) Assignee: ZHEJIANG JIANRUI TECHNOLOGY CO., LTD., Zhejiang (CN)

(21) Appl. No.: 18/337,048

(22) Filed: Jun. 19, 2023

(30) Foreign Application Priority Data
Jun. 23, 2022 (CN) 202210720016.4

(51) Int. Cl. A01B 69/04; A01M 21/04

(52) U.S. Cl. CPC A01B 69/008; A01M 21/043

(57) ABSTRACT

The invention discloses a path finding method and system for a weeding robot. The path finding method comprises: performing path finding by a weeding robot, wherein comprises: mounting magnetic tacks on a boundary of a weeding area and around obstacles; determining, in a two-dimensional array map, an initial position of the weeding robot; starting to find a path; when it is determined, by logic, that no moving direction is available at a point where the weeding robot arrives, searching backward for an available operating position according to points that the weeding robot has passed; when an operating point is found, allowing the weeding robot to move with a current position of the weeding robot as an initial position and the operating point as an end point; when the moving robot reaches the operating point, perform path finding; and when no operating point is found, ending the path finding process.

### CROSS-REFERENCE TO RELATED APPLICATION

This application claims the priority benefit of China application serial no. 202210720016.4, filed on Jun. 23, 2022. The entirety of the above-mentioned patent application is hereby incorporated by reference herein and made a part of this specification.

### BACKGROUND

### Technical Field

The invention belongs to the technical field of weeding robots, and particularly relates to a path finding method and system for a weeding robot.

### Description of Related Art

As is commonly known, smart weeding robots are AI weeding robots capable of realizing targeted pesticide spraying and accurate weeding to reduce unnecessary pesticide waste and pollution. The smart weeding robots can reduce the pesticide spraying area, such that pesticide waste is avoided, and the situation where a large amount of pesticide is left on crops and in soil is also avoided.

In recent years, with the rapid development of science and technology, weeding robots are used more and more widely. At present, most weeding robots integrates the sensor technique and the communication technique; it is found in use of weeding robots that automatic path-finding of the weeding robots is one of the important links for guaranteeing normal operation of the weeding robots. At present, path finding of weeding robot is realized mainly through GPS positioning or communication network positioning. However, it is found in practice that these traditional techniques have the following defects: first, positioning errors are large; and second, signals are weak in some special regions. So, it is of great importance to design and develop a high-precision and high-speed path finding method and system for weeding robots.

### SUMMARY

### Technical Purposes

The invention provides a path finding method and system for a weeding robot to realize high-accuracy positioning and rapid path-finding of the weeding robot.

### Technical Solution

A first objective of the invention is to provide a path finding method for a weeding robot, which comprises:

Step 1: drawing a blueprint, which specifically comprises:

Step 101: acquiring a target map of a weeding area, and partitioning the target map into grids;

Step 102: determining the type of the grids, wherein the type of the grids indicates whether the grids are obstacle grids or blank grids;

Step 103: performing binarization processing on the grids according to the type of the grids to form a two-dimensional array map;

S2: performing path finding by a weeding robot, which specifically comprises:

Step 201: mounting magnetic tacks on a boundary of the weeding area and around obstacles; Step 202: determining, in the two-dimensional array map, an initial position of the weeding robot;

Step 203: starting to find a path, specifically: recording a direction of the initial position and determining whether there is a magnetic tack on a leftmost side, by the weeding robot;

if there is no magnetic tack, allowing the weeding robot to move leftwards in the current direction, and recording a path that the weeding robot passes in this direction;

if there is a magnetic tack, allowing the weeding robot to shift clockwise sequentially from the leftmost side in the current direction, and determining, after each shift, whether there is an obstacle in the current direction; if there is no obstacle, determining, according to coordinates of points that the weeding robot has passed, whether the weeding robot has passed a current point; if not, allowing the weeding robot to move in the current direction; otherwise, repeating the determination process, and recording the position of the magnetic tack;

Step 204: during the operating process, when it is determined, by logic, that no moving direction is available at a point where the weeding robot arrives, searching backward for an available operating position according to the points that the weeding robot has passed, and in this case, performing cyclic calculation directly according to recorded positions of magnetic tacks;

when an operating point is found, allowing the weeding robot to move with a current position of the weeding robot as an initial position and the operating point as an end point;

Step 205: when the moving robot reaches the operating point, repeating S03 to perform path finding;

Step 206: when no operating point is found for the weeding robot through S204, ending the path finding process; and

Step 3: when the weeding robot returns to a base station, drawing a two-dimensional array in the two-dimensional array map according to a recorded moving trajectory and the positions of the magnetic tacks, and then scaling down redundant map edges through a map clipping technique.

Preferably, Step 101 specifically comprises: determining a grid size and then partitioning the target map into grids.

Preferably, wherein a distance between every two adjacent said magnetic tacks is less than a distance between axles of a front wheel and a rear wheel of the weeding robot, and is not less than half of the distance between the axles of the front wheel and the rear wheel of the weeding robot.

Preferably, wherein Step 201 further comprises: setting the base station.

Preferably, wherein in Step 203, a shift angle is 10°.

Preferably, wherein in Step 204, when the operating position is found, an optimal moving trajectory is obtained through an a* algorithm, and then the weeding robot moves.

Preferably, wherein in Step 206, after path finding is completed, the weeding robot returns to the base station through an a* algorithm, with a current position with an initial point and the base station as an end point.

A second objective of the invention is to provide a path finding system for a weeding robot, which comprises:

a map module used for drawing a blueprint, specifically:

acquiring a target map of a weeding area, and partitioning the target map into grids;

determining the type of the grids, wherein the type of the grids indicates whether the grids are obstacle grids or blank grids;

performing binarization processing on the grids according to the type of the grids to form a two-dimensional array map;

a path finding module used for path finding of a weeding robot, specifically:

mounting magnetic tacks on a boundary of the weeding area and around obstacles;

determining, in the two-dimensional array map, an initial position of the weeding robot;

starting to find a path by logic A and logic B, specifically: recording a direction of the initial position and determining whether there is a magnetic tack on a leftmost side, by the weeding robot;

logic A: if there is no magnetic tack, allowing the weeding robot to move leftwards in the current direction, and recording a path that the weeding robot passes in this direction; if there is a magnetic tack, allowing the weeding robot to shift clockwise sequentially from the leftmost side in the current direction, and determining, after each shift, whether there is an obstacle in the current direction; if there is no obstacle, determining, according to coordinates of points that the weeding robot has passed, whether the weeding robot has passed a current point; if not, allowing the weeding robot to move in the current direction; otherwise, repeating the determination process, and recording the position of the magnetic tack;

logic B: during the operating process, when it is determined, by logic, that no moving direction is available at a point where the weeding robot arrives, searching backward for an available operating position according to the points that the weeding robot has passed, and in this case, performing cyclic calculation directly according to recorded positions of magnetic tacks;

when an operating point is found, allowing the weeding robot to move with a current position of the weeding robot as an initial position and the operating point as an end point;

when the moving robot reaches the operating point, repeating logic A to perform path finding;

when no operating point is found for the weeding robot through logic B, ending the path finding process; and

a map revision module used for, when the weeding robot returns to a base station, drawing a two-dimensional array in the two-dimensional array map according to a recorded moving trajectory and the positions of the magnetic tacks, and then scaling down redundant map edges through a map clipping technique.

A third object of the invention is to provide a computer program for implementing the path finding method for a weeding robot.

A fourth objective of the invention is to provide an information data processing terminal for implementing the path finding method for a weeding robot.

A fifth objective of the invention is to provide a computer-readable storage medium, which comprises an instruction, which, when running on a computer, enables the computer to implement the path finding method for a weeding robot.

The invention has the following advantages and beneficial effects:

The path finding method and system for a weeding robot provided by the invention can quickly and accurately plan a weeding path and avoid a repeated path, such that a shortest path is found, and the working efficiency is improved.

### BRIEF DESCRIPTION OF THE DRAWINGS

FIG. 1 is a structural diagram of a magnetic tack in a preferred embodiment of the invention;

FIG. 2 is a schematic diagram of a weeding robot in the preferred embodiment of the invention;

FIG. 3 is a schematic diagram of grid positioning in the preferred embodiment of the invention;

FIG. 4 illustrates a two-dimensional array map in the preferred embodiment of the invention;

FIG. 5 is a diagram of a moving path in the preferred embodiment of the invention;

FIG. 6 illustrates a moving scope in the preferred embodiment of the invention;

FIG. 7 illustrates a planned path in the preferred embodiment of the invention;

FIG. 8 illustrates a planning scope in the preferred embodiment of the invention.

### DESCRIPTION OF THE EMBODIMENTS

To gain a further understanding of the contents, features and effects of the invention, the invention will be described in detail below with reference to the following embodiments and accompanying drawings.

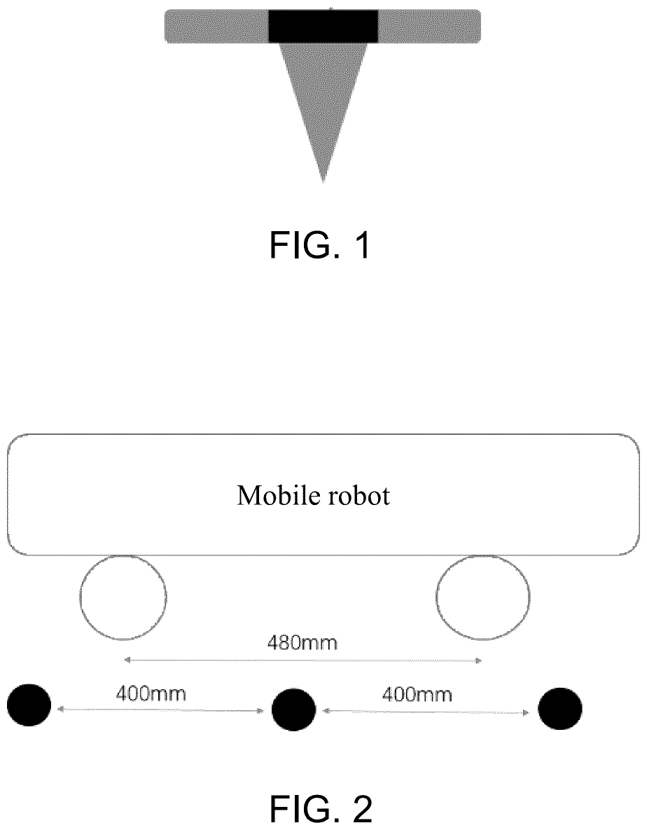

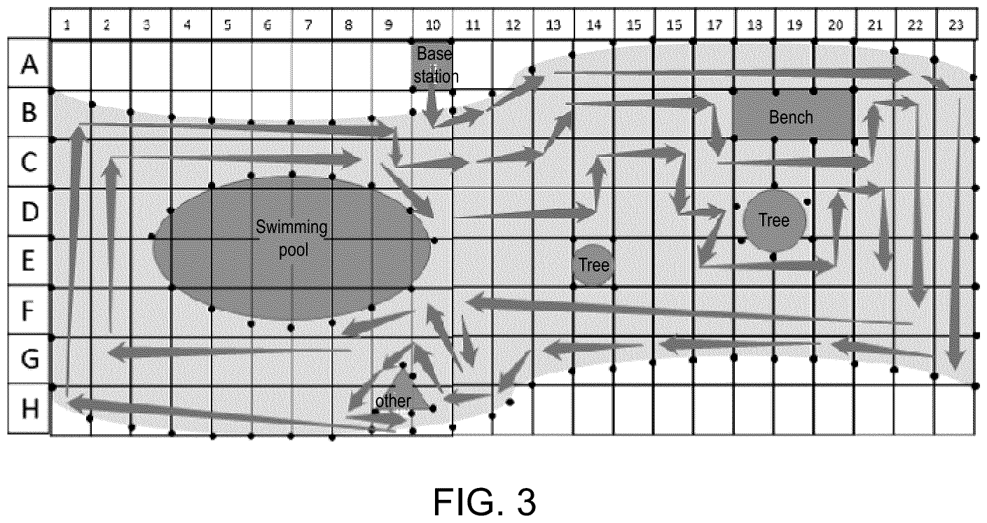

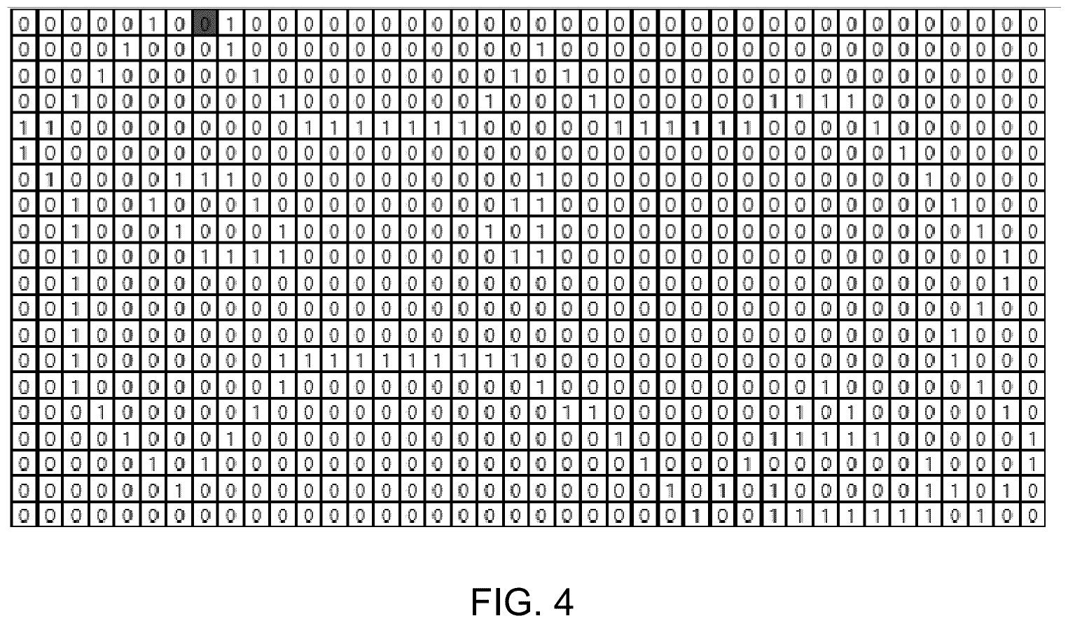

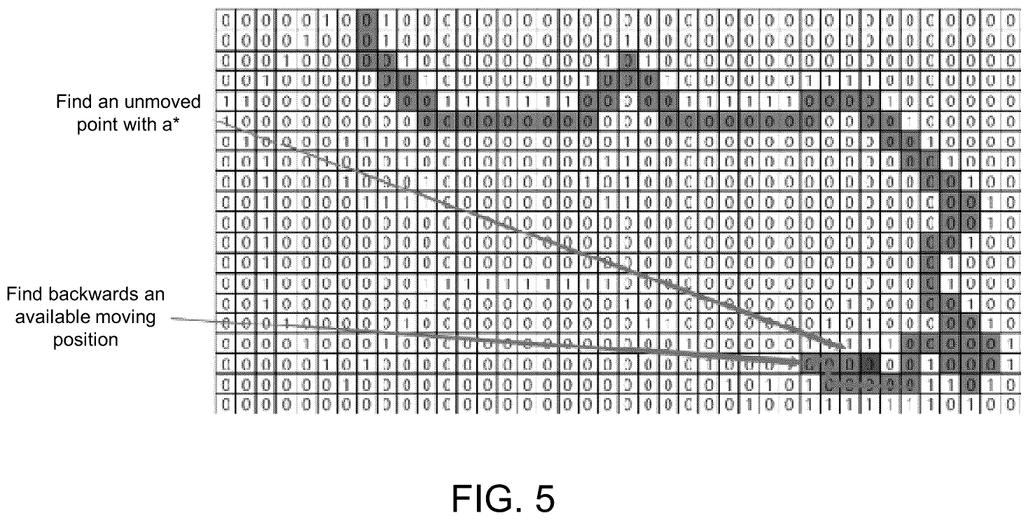

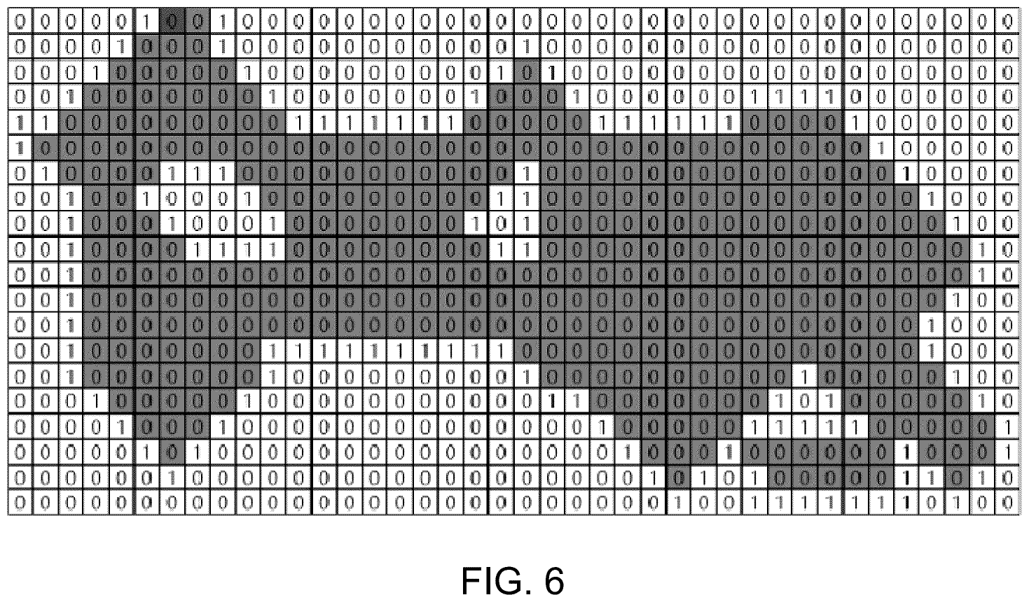

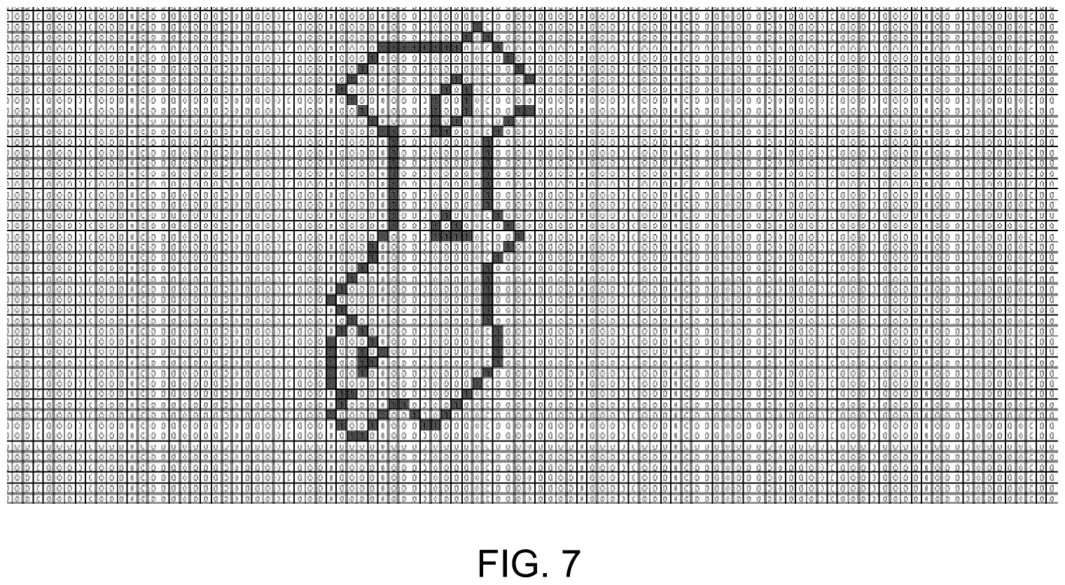

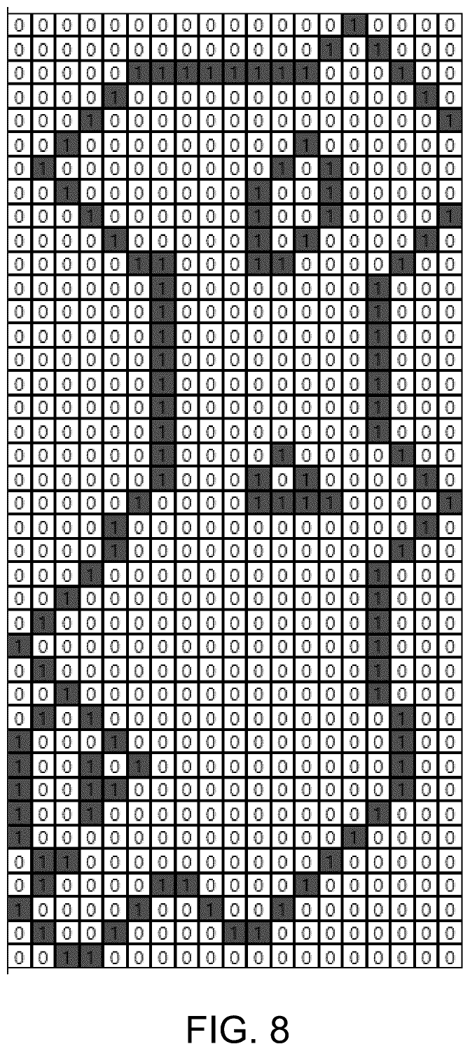

Referring to FIG. 1-FIG. 8:

In this application, an optical coding disk, a magnetic sensor, a direction sensor and an acceleration sensor are integrated on a weeding robot. Wherein, the optical coding disk is used for calculating the step size in the path finding process. The magnetic sensor is used for probing magnetic tacks in the path finding process, and the boundary of a field and obstacles are determined according to the positions and directions of the magnetic tacks. The direction sensor is used for determining the direction and angle of the head of the weeding robot in the path finding process to determine a current position and a direction in which the weeding robot moves later. The acceleration sensor is sued for controlling the moving speed of the weeding robot.

The structure of the magnetic tacks is as follows: the top is flat, the bottom is pointed, and the middle (key position) is made of a permanent magnet; the top edge is widened to effectively prevent settlement when users step on the magnetic tacks or the magnetic tacks are affected by environmental factors, such that the problem that the magnetic sensor cannot detect the magnetic tacks in the path finding process is avoided.

Before path finding, magnetic tacks are mounted in a target filed in advance to determine the path finding range in the field. To ensure that the weeding robot can defect the magnetic field when moving to the boundary, reasonable distribution of the magnetic tacks on the boundary of the working area is of great importance. If the distance between a front wheel and a rear wheel of the mobile robot is 480 mm, the distance between the magnetic tacks should be less than 480 mm to ensure that a magnetic sensor group can detect the magnetic field every time the robot reaches the boundary; without the loss of generality, considering that there may be some permanent magnets scattered in the lawn, in order to ensure that the robot can accurately determine the working boundary, only when the magnetic sensor group of the robot synchronously detects two or more (including two) magnetic tacks, it will be determined that the robot reaches the boundary; and considering the economical factor, the magnetic tacks should not be distributed too densely, and a suitable distance between the magnetic tacks is 400 mm.

A path finding method for a weeding robot comprises:

Blueprint Drawing:

Intelligent drawing of a blueprint is the basis for the weeding robot to realize mobile navigation and path planning. According to a grid method, the working space of the mobile robot is divided into a plurality of grids, then the state of the grids is determined by means of a sensor, and generally, the grids are obstacle grids or blank grids. Full-path coverage searching can be realized in a two-dimensional grid network with binary information through an algorithm. When the actual working map of the robot is divided into grids, the grid size of the grids should be properly determined, which is of great importance.

Accurate positioning of the weeding robot is one of the keys to completing navigation and control tasks. The positioning techniques include an absolute positioning technique and a relative positioning technique. An odometer and a photoelectric encoder are used most commonly. A gyroscope and an accelerometer are used for an inertial navigation method.

The relative positioning technique and the absolute positioning technique are often used in combination in a positioning system according to their advantages and disadvantages, and data obtained through the relative positioning technique and the absolute positioning technique is integrated to realize real-time and accurate positioning. In case of local path planning and navigation, the optical coding disk and the direction sensor are mainly used; and in case of global path planning and navigation, an accumulative error generated by the optical coding disk is corrected to guarantee the accuracy and reliability of the positioning system.

Path Finding

1. Before path finding, the mounting distance of the magnetic tacks is measured according to the boundary of the field, wherein if the distance between the front wheel and the rear wheel of the mobile robot is 480 mm, and mounting distance of the magnetic tacks is at least 400 mm.

2. After the magnetic tacks are mounted on the boundary of the field, magnetic tacks are mounted around obstacles, such that the mobile robot can sense the obstacles through the magnetic sensor.

3. A base station is set, wherein the base station is of great importance in the path finding process of the mobile robot and determines an initial position and direction of the mobile robot and an end point of path finding; and the base station can be used for charging, rain protection, or other maintenance functions.

4. Before path finding, a system automatically constructs a two-dimensional array map model for path finding, wherein the size of the two-dimensional array map model is at least 1000*1000; and the initial position of the mobile robot is the center of the map model (500, 500).

5. When path finding starts, the mobile robot determines, through the magnetic sensor, whether there is a magnetic tack on the leftmost side according to the direction of the initial position recorded by the direction sensor; if there is no magnetic tack, the mobile robot moves towards the leftmost side in the current direction, and the path that the mobile robot passes is recorded by the optical coding disk; if a magnetic tack is detected, the mobile robot will not move in this direction and will shift clockwise sequentially from the leftmost side in the current direction (it is verified through field measurement that the optimal shift angle is 10°); after each shift, whether there is an obstacle in the current direction is detected through the magnetic sensor; if there is no obstacle, whether the mobile robot has passed a current point is determined according to coordinates of points that the mobile robot has passed; if the robot has not passed the current point, the mobile robot will be steered through a steering device on the mobile robot, and then advance in this direction; if the mobile robot has passed the current point, the determination process is repeated, and the positions of magnetic stacks encountered by the mobile robots are recorded in this process.

In the moving process, when the magnetic sensor detects a magnetic tack, it indicates that the mobile robot encounters the boundary or an obstacle, the mobile robot stops advancing instantly, data in the moving process is recorded, and then the above operation is repeated.

6. During the operating process, when it is determined, by detecting magnetic tacks through the magnetic sensor, that no moving direction is available at a point where the weeding robot arrives, an available operating position is searched for backward according to the points that the weeding robot has passed, and in this case cyclic calculation is performed directly according to recorded positions of the magnetic tacks rather than the positions of magnetic tacks detected by the magnetic sensor.

7. When an operating point is found, the weeding robot moves directly, with the current position of the weeding robot as an initial position and the operating point as an end point; in this case, an optimal moving trajectory is obtained through an a* algorithm, and then the weeding robot moves quickly.

8. When the moving robot reaches the operating point, Step 5 is repeated to perform path finding.

9. When no operating point is found for the weeding robot through Step 6, it indicates that path finding is completed, and at this moment, the weeding robot returns to the base station quickly through the a* algorithm, with the current position with an initial point and the base station as an end point.

10. When the weeding robot returns to a base station, a two-dimensional array will be drawn in the 1000*1000 two-dimensional array map by the system according to the recorded moving trajectory and the positions of the magnetic tacks, and then redundant map edges are scaled down through a map clipping technique. At this moment, the whole path finding process is ended.

A path finding system for a weeding robot comprises:

A map module used for drawing a blueprint, specifically:

Acquiring a target map of a weeding area, and partitioning the target map into grids;

Determining the type of the grids, wherein the type of the grids indicates whether the grids are obstacle grids or blank grids;

Performing binarization processing on the grids according to the type of the grids to form a two-dimensional array map;

A path finding module used for path finding of a weeding robot, specifically:

Mounting magnetic tacks on a boundary of the weeding area and around obstacles;

Determining, in the two-dimensional array map, an initial position of the weeding robot;

Starting o find a path, specifically: recording a direction of the initial position and determining whether there is a magnetic tack on a leftmost side, by the weeding robot;

Logic A: if there is no magnetic tack, allowing the weeding robot to move leftwards in the current direction, and recording a path that the weeding robot passes in this direction; if there is a magnetic tack, allowing the weeding robot to shift clockwise sequentially from the leftmost side in the current direction, and determining, after each shift, whether there is an obstacle in the current direction; if there is no obstacle, determining, according to coordinates of points that the weeding robot has passed, whether the weeding robot has passed a current point; if not, allowing the weeding robot to move in the current direction; otherwise, repeating the determination process, and recording the position of the magnetic tack;

Logic B: during the operating process, when it is determined, by logic, that no moving direction is available at a point where the weeding robot arrives, searching for an available operating position according to the points that the weeding robot has passed, and in this case, performing cyclic calculation directly according to recorded positions of magnetic tacks;

When an operating point is found, allowing the weeding robot to move with a current position of the weeding robot as an initial position and the operating point as an end point; When the moving robot reaches the operating point, repeating logic A to perform path finding;

When no operating point is found for the weeding robot through logic B, ending the path finding process; and

A map revision module used for, when the weeding robot returns to a base station, drawing a two-dimensional array in the two-dimensional array map according to a recorded moving trajectory and the positions of the magnetic tacks, and then scaling down redundant map edges through a map clipping technique.

A computer program is used for implementing the path finding method for a weeding robot.

An information data processing terminal is used for implementing the path finding method for a weeding robot.

A computer-readable storage medium comprises an instruction, wherein the instruction, when running on a computer, enables the computer to implement the path finding method for a weeding robot.

All or part of the above embodiments may be implemented through software, hardware, firmware, or any combination of software, hardware and firmware. When all or part of these embodiments is implemented in the form of a computer program product, the computer program product comprises one or more computer instructions. When the computer instruction is loaded or executed on a computer, all or part of the processes or functions in the embodiments of the invention are implemented. The computer may be a general-purpose computer, a special-purpose computer, a computer network, or other programmable devices. The computer instruction may be stored in a computer-readable storage medium, or transmitted from one computer-readable storage medium to the other computer-readable storage medium, for example, the computer instruction may be transmitted from one network, computer, server or data center to another website, computer, server or data center in a wired manner (such as by a coaxial cable, an optical fiber or a digital subscriber line (DSL)) or a wireless manner (such as by infrared rays, radio or microwaves). The computer-readable storage medium may be any available media capable of being stored in a computer, or a data storage device formed by one or more available media, such as a server or a data center. The available medium may be a magnetic medium (such as floppy disk, hard disk or magnetic tape), an optical medium (such as a DVD), or a semiconductor medium (such as a solid state disk (SSD)).

The above embodiments are merely preferred ones of the invention, and are not used to limit the invention in any forms. Any simple amendments, equivalent changes and modifications made to the above embodiments according to the technical essence of the invention should fall within the scope of the technical solution of the invention.

What is claimed is:

1. A path finding method for a weeding robot, comprising the following steps:
Step 1: drawing a blueprint, which comprises:
Step 101: acquiring a target map of a weeding area, and partitioning the target map into grids;
Step 102: determining the type of the grids, wherein the type of the grids indicates whether the grids are obstacle grids or blank grids;
Step 103: performing binarization processing on the grids according to the type of the grids to form a two-dimensional array map;
Step 2: performing path finding by a weeding robot, which comprises:
Step 201: mounting magnetic tacks on a boundary of the weeding area and around obstacles;
Step 202: determining, in the two-dimensional array map, an initial position of the weeding robot;
Step 203: starting to find a path, recording a direction of the initial position and determining whether there is a magnetic tack on a leftmost side, by the weeding robot;
if there is no magnetic tack, allowing the weeding robot to move leftwards in the current direction, and recording a path that the weeding robot passes in this direction;
if there is a magnetic tack, allowing the weeding robot to shift clockwise sequentially from the leftmost side in the current direction, and determining, after each shift, whether there is an obstacle in the current direction; if there is no obstacle, determining, according to coordinates of points that the weeding robot has passed, whether the weeding robot has passed a current point; if not, allowing the weeding robot to move in the current direction; otherwise, repeating the determination process, and recording the position of the magnetic tack;
Step 204: during the operating process, when it is determined, by logic, that no moving direction is available at a point where the weeding robot arrives, searching backward for an available operating position according to the points that the weeding robot has passed, and in this case, performing cyclic calculation directly according to recorded positions of magnetic tacks;
when an operating point is found, allowing the weeding robot to move with a current position of the weeding robot as an initial position and the operating point as an end point;
Step 205: when the moving robot reaches the operating point, repeating S03 to perform path finding;
Step 206: when no operating point is found for the weeding robot through S204, ending the path finding process; and
Step 3: when the weeding robot returns to a base station, drawing a two-dimensional array in the two-dimensional array map according to a recorded moving trajectory and the positions of the magnetic tacks, and then scaling down redundant map edges through a map clipping technique.

2. The path finding method for a weeding robot according to claim 1, wherein Step 101 comprises: determining a grid size and then partitioning the target map into grids.

3. The path finding method for a weeding robot according to claim 1, wherein a distance between every two adjacent said magnetic tacks is less than a distance between axles of a front wheel and a rear wheel of the weeding robot, and is not less than half of the distance between the axles of the front wheel and the rear wheel of the weeding robot.

4. The path finding method for a weeding robot according to claim 1, wherein Step 201 further comprises: setting the base station.

5. The path finding method for a weeding robot according to claim 1, wherein in Step 203, a shift angle is 10°.

6. The path finding method for a weeding robot according to claim 1, wherein in Step 204, when the operating position is found, an optimal moving trajectory is obtained through an a* algorithm, and then the weeding robot moves.

7. The path finding method for a weeding robot according to claim 1, wherein in Step 206, after path finding is completed, the weeding robot returns to the base station through an a* algorithm, with a current position with an initial point and the base station as an end point.

8. A path finding system for a weeding robot, comprising:
a map module used for drawing a blueprint, which is configured to:
acquiring a target map of a weeding area, and partitioning the target map into grids;
determining the type of the grids, wherein the type of the grids indicates whether the grids are obstacle grids or blank grids; and
performing binarization processing on the grids according to the type of the grids to form a two-dimensional array map;
a path finding module used for path finding of a weeding robot, which is configured to:
mounting magnetic tacks on a boundary of the weeding area and around obstacles;
determining, in the two-dimensional array map, an initial position of the weeding robot;
starting to find a path with logic A and logic B, recording a direction of the initial position and determining whether there is a magnetic tack on a leftmost side, by the weeding robot; wherein
logic A: if there is no magnetic tack, allowing the weeding robot to move leftwards in the current direction, and recording a path that the weeding robot passes in this direction; if there is a magnetic tack, allowing the weeding robot to shift clockwise sequentially from the leftmost side in the current direction, and determining, after each shift, whether there is an obstacle in the current direction; if there is no obstacle, determining, according to coordinates of points that the weeding robot has passed, whether the weeding robot has passed a current point; if not, allowing the weeding robot to move in the current direction; otherwise, repeating the determination process, and recording the position of the magnetic tack;
logic B: during the operating process, when it is determined, by logic, that no moving direction is available at a point where the weeding robot arrives, searching backward for an available operating position according to the points that the weeding robot has passed, and in this case, performing cyclic calculation directly according to recorded positions of magnetic tacks;
when an operating point is found, allowing the weeding robot to move with a current position of the weeding robot as an initial position and the operating point as an end point;
when the moving robot reaches the operating point, repeating logic A to perform path finding; and
when no operating point is found for the weeding robot through logic B, ending the path finding process; and
a map revision module, which is configured to:
when the weeding robot returns to a base station, drawing a two-dimensional array in the two-dimensional array map according to a recorded moving trajectory and the positions of the magnetic tacks, and then scaling down redundant map edges through a map clipping technique.

9. An information data processing terminal for implementing the path finding method for a weeding robot according to claim 1.

10. A computer-readable storage medium, comprising an instruction, wherein the instruction, when running on a computer, enables the computer to implement the path finding method for a weeding robot according to claim 1.
